(19) United States
(12) Patent Application Publication
(10) Pub. No.: US 2008/0067011 A1
(43) Pub. Date: Mar. 20, 2008

(54) METHOD OF CHECKING ELEVATOR BRAKING EQUIPMENT, A METHOD FOR PLACING AN ELEVATOR IN OPERATION AND EQUIPMENT FOR CARRYING OUT PLACING IN OPERATION

(76) Inventors: Nicolas Gremaud, Wadenswil (CH); Steffen Grundmann, Bonstetten (CH)

Correspondence Address: FRASER CLEMENS MARTIN & MILLER LLC, 28366 KENSINGTON LANE, PERRYSBURG, OH, 43551, US

(21) Appl. No.: 11/765,126

(22) Filed: Jun. 19, 2007

Related U.S. Application Data
(60) Provisional application No. 60/805,125, filed on Jun. 19, 2006.

(30) Foreign Application Priority Data
Jun. 19, 2006 (EP) 06115686.5

(51) Int. Cl. B66B 5/16

(52) U.S. Cl. 187/359

(57) ABSTRACT

In this lift installation, lift braking equipment (11) brakes and holds a lift cage (2). The lift braking equipment (13) consists of a number of brake units (12) which when required are brought into engagement with brake tracks (6), wherein the brake unit (12) for this purpose presses at least one brake plate (14) against the brake track (6) and produces a braking force (FB). According to the invention, for checking the braking equipment (11) an effective coefficient of friction (μe), which is generated during pressing of the brake plate (14) against the brake track (6), of the brake unit is ascertained. Moreover, a placing in operation with use of this checking method is illustrated and equipment for performing this placing in operation is presented.

The invention relates to a method of checking lift braking equipment, a method for placing a lift installation in operation and equipment for carrying out placing in operation, according to the introductory part of the independent patent claims.

A lift installation is incorporated in a shaft. It substantially consists of a lift cage which is connected by way of support means with a counterweight. The cage is moved along a substantially vertical cage travel path by means of a drive which selectably acts on the support means, directly on the cage or directly on the counterweight. Lift installations of that kind have mechanical braking systems which enable holding of the cage at a desired location, can brake the lift installation or the moved masses thereof in normal operation or can safely stop the lift cage in the case of a fault. Holding at a desired location is, for example, holding of the lift cage at a storey for the purpose of unloading or loading or for waiting for a next travel command. Braking in normal operation is, for example, a stopping process when the cage moves into a storey and braking in the case of fault is required when, for example, a control, the drive or the support means fails.

Until now two braking systems were usually used for these requirements, of which one was arranged at the drive itself and the other on the cage. A check of these systems is costly, because on the one hand two systems have to be checked and on the other hand fully laden cages are normally required for the check. This is complicated inasmuch as a useful load for the cage has to be transported up. This load has to be transported a number of times in small load portions and during the test there is a risk of damage of items of cage equipment by slipping of this useful load.

A braking system is now known from our application EP 05111993.1 which uses only one braking system instead of two braking systems. The illustrated lift braking equipment brakes and holds a lift cage and the lift braking equipment consists of a number of brake units which can be brought into engagement with brake tracks in the case of need, wherein the brake unit for this purpose presses at least one brake plate against the brake track and generates a braking force.

This braking system must now be able to be checked particularly securely and, nevertheless, efficiently.

The object of this invention is accordingly to design a checking method enabling efficient and reliable checking of braking equipment of that kind. Placing of a corresponding lift installation in operation shall be able to be made simple. Preferably there shall be able to be early recognition of possible faults and important installation data shall be able to be verified.

According to the invention these objects are fulfilled in that a number of brake units which are brought into engagement with brake tracks as required and which press at least one brake plate against the brake track are checked in that an effective coefficient of friction, which is generated when the brake plate is pressed against the brake track, of the brake unit is ascertained. Through ascertaining the effective coefficient of friction of the brake unit, deviations can be recognised in good time and the ascertaining allows a reliable statement with respect to the functional capability of the braking unit. The monitoring can, through corresponding ascertaining, be verified continuously, i.e. with each use, which enables a particularly safe construction of a brake unit of that kind.

In an advantageous construction the effective coefficient of friction (μe) of the brake unit is ascertained by means of a braking force measuring device for measuring a braking force and by means of a normal force measuring device for measuring a brake adjusting force which acts. This is particularly advantageous, since force measurements, for example with use of strain gauges, can be constructed economically. In addition, an effective resulting coefficient of friction of a brake unit can be ascertained in very simple manner with use of these measuring magnitudes.

A variant of embodiment proposes that for ascertaining the effective coefficient of friction (μe) of the brake unit the brake unit is brought into engagement with the brake track and adjusted with a brake adjusting force (FNw) having a lesser action, and the lift cage is moved at low speed, wherein the process of movement is continued or repeated until a substantially constant effective coefficient of friction (μe=FB/FNw) of the brake unit sets in. This is particularly advantageous, since during mounting of a lift installation dirt and construction dust can adhere to the brake track. This influences a coefficient of friction and thus also a resulting braking force. With the illustrated method this dirt can be rubbed away and the success of the cleaning can be checked by means of checking the coefficient of friction. At the same time it can be checked whether the measured coefficient of friction corresponds with a value according to experience. This enables coarse assessment of the material used, for example whether the correct brake track material is used.

A very advantageous variant of checking proposes that the ascertaining of the effective coefficient of friction (μe) of the brake unit is carried out at the unladen lift cage. This is of economic interest inasmuch as a useful load does not have to be used for the purpose of checking braking equipment. The time requirement for transport of check weights is eliminated and a risk of damage of lift equipment does not exist.

A helpful variant of embodiment proposes that a sufficient brake safety factor (SB) is evidenced on the basis of the effective coefficient of friction ([Le) and a maximum brake adjusting force (FNm) ascertained by means of the normal force measuring device. A safety factor is a characteristic for the reliability of equipment or the certainty of fulfillment of a task by equipment. Such a brake safety factor is particularly important in the case of braking equipment.

A checking method of that kind for checking lift braking equipment according to the foregoing embodiments is used with particular advantage for placing in operation a lift installation with lift braking equipment of that kind. The lift installation includes a lift cage for transporting a load, which is to be conveyed, and a counterweight, which is connected with the lift cage by means of support means, and a drive for driving the lift cage, counterweight and support means, wherein counterweight and cage move in a substantially vertical shaft in opposite sense. In the case of a lift installation of that kind the assessment of lift braking equipment is particularly difficult, since a complex mass system is involved. The proposed checking method in this connection offers an efficient and safe possibility for placing the lift installation in operation.

A lift installation is a complex mass system and lift braking equipment has to be appropriate to this complex mass system. As a rule, i.e. in normal operational states, the lift braking equipment of a lift installation has to bring the entire mass system or the total mass (MG), which is to be braked, to a standstill. In a ‘worst case’, for example in the event of failure of support means or support structures, it is necessary, however, for the lift braking equipment to be able to securely brake and hold the residual mass (MV), essentially the mass of the empty lift cage inclusive of the additional load. This latter requirement cannot be actually checked in a lift installation, since for this purpose a ‘worst case’ of that kind—also termed ‘free fall’ in the field of lift construction—would have to be produced. Consequently, in order to make a reliable statement with respect to the safety of lift braking equipment—and a statement of that kind is a constituent of placing the lift installation in operation—the participating masses have to be known. The invention now proposes helpful variants of embodiment for ascertaining these masses.

The first variant of embodiment proposes that the residual mass (MV), which has to be braked by the lift braking equipment in the ‘worst case’, of the lift installation is calculated with input of a permissible weight (MF) of the load, which is to be conveyed, and input of a weight (MK) of the empty lift cage (MV=MK+MF). This can be realised in simple manner and is possible in lift installations with pronounced standardisation, where no customer-specific designs are admitted.

Another variant of embodiment proposes that the residual mass (MV), which is to be braked by the lift braking equipment in the ‘worst case’, of the lift installation is calculated with input of the permissible weight (MF) of the load, which is to be conveyed, and an effective mass part of the drive (MA) and measurement of a lift acceleration (ak), wherein mass determinations at the lift installation, such as an actual imbalance (MB) of the lift installation or an actual weight (MT) of the support means are carried out with use of the braking force measuring device. This variant is advantageous when customer-specific lift installations are concerned, in which, for example, additional apparatus such as image screens, air-conditioning systems or the like or equipment articles such as mirrors, decorative materials or a customer-specific floor covering are installed. This method allows reliable determination of the masses to be braked.

The operative mass parts of the drive (MA) are defined by the drive. These are the inertia masses of the drive inclusive of associated drive pulleys and deflecting rollers. These rotational inertial masses are recalculated in correspondence with the diameter of the drive pulley to an equivalent linear mass proportion of the drive (MA). These values are apparent from lift documents or given in the form of data tables to checking apparatus.

The actual imbalance (MB) denotes the mass difference between counterweight and empty cage. As a rule this mass difference is interpreted as 50% of the permissible load (MF) to be conveyed. However, other interpretations of this imbalance are also known. This imbalance can be ascertained in that initially an actual weight (MT) of-the support means is determined. This is advantageously carried out by measuring the holding force (FB_{HT}) in the rest state with the cage parked at the uppermost stop (HT) and measurement of the holding force (FB_{HB}) in the rest state with the cage parked at the lowermost stop (HT); The measurement of the holding forces (FB_{HT}, FB_{HB}) is carried out in each instance in that the lift cage is fixed at the relevant stop (uppermost or lowermost) solely by the braking equipment and the holding force is measured by means of the braking force measuring device. The actual weight of the support means can be determined from the difference of these two measurements according to the following formula:
Mass Support Means (MT)=(Holding Force (FB_{HT})−Holding Force (FB_{HB}))/2/g

wherein g is gravitational acceleration (9.81 m/s²).

The actual imbalance (MB) can be determined from, for example, the sum of these two measurements according to the following formula:
Mass Imbalance (MB)=(Holding Force (FB_{HT})−Holding Force (FB_{HB}))/2/g

wherein g is again the gravitational acceleration (9.81 m/s²). In all cases it is necessary in this determination to take into account a weight (MZ) of a possible useful load of the cage (for example, an installer).

The weight (MK) of the empty lift cage can now be ascertained in that, for example, an intrinsic acceleration (ak) of the lift cage is measured by means of an acceleration sensor. In this connection the empty cage is parked at the lowermost stop (HB), then the braking equipment released, whereby the empty lift cage automatically accelerates upwardly. This acceleration (ak) and a possible residual braking force (FB_{R}) are measured and subsequently the brake is applied again.

The actual weight (MK) of the empty lift cage can now be determined, for example, with use of the values ascertained as aforesaid or values which are known, according to the following formula:
MK=((MB−MT−MZ)*g−(MT+MZ+MA+MB)*ak−FBR)/ak.
The residual mass (MV), which is to be braked by the lift braking equipment in the ‘worst case’, can now be calculated:
MV=MK+MF.

This method allows secure ascertaining of the actual mass proportions of a lift installation.

Advantageously, a maximum required brake adjusting force (FNe) is determined with consideration of the total mass (MV) to be braked in the ‘worst case’, the effective coefficient of friction (μe) of the brake unit, the number (N) of brake units used, a requisite minimum retardation (ake) and a correction factor (KB1), wherein the correction factor (KB) takes into consideration empirical values such as speed of braking, contamination or anticipated overload:
FNe=KB1*MG*(ake+G)/(N*(μe).

This allows an effective prediction of the required adjusting force (FNe) with little effort. The required measurements can be undertaken by one person alone and no test weights are required.

A further refinement proposes that the brake unit is adjusted with a maximum force and the maximum brake adjusting force (FNm), which is achievable in that manner, is measured by means of the normal force measuring device and this maximum brake adjusting force (FNm) is compared with the maximum required brake adjusting force (FNe), evidence of sufficient braking function being designated fulfilled when the maximum brake adjusting force (FNm) is greater by the safety factor (SB) than the maximum required brake adjusting force (FNe). This embodiment allows a statement with respect to an actually present safety of the braking equipment. This gives very safe braking equipment.

Alternatively, the brake unit is adjusted with a maximum force and the maximum brake adjusting force (FNm), which is achievable in this manner, is measured by means of the normal force measuring device and a maximum possible braking force is determined with consideration of the effective coefficient of friction (μe) of the brake unit, the number (N) of brake units used and a correction factor (KB2), wherein the correction factor (KB2) takes account of characteristic empirical values such as speed of braking or contamination:
FBm=KB2*2*FNm*N*te.

This allows a direct statement with respect to maximum possible braking capacity of the braking equipment, which is used, in a specific lift installation.

Advantageously, based on the preceding statement with respect to maximum possible braking force (FBm), a maximum required braking force (FBe) is determined with consideration of the weight (MV) which is to be braked in the ‘worst case’, a required minimum retardation (ake) and a correction factor (KB2′):
FBe=KB2′*MV*(ake+G).

The correction factor (KB2′) takes into account characteristic empirical values such as anticipated overload. The maximum possible braking force (FBm) is now compared with the maximum required braking force (FBe) and evidence of sufficient braking function is designated fulfilled when the maximum possible braking force (FBm) is greater than the maximum required braking force (FBe) by the safety factor (SB).

This method gives a comprehensive overview of braking safety of a lift installation.

In an advantageous refinement of the method for placing a lift installation in operation the braking function is generally verified in that the empty cage is accelerated in controlled or uncontrolled manner, preferably in upward direction, until a travel curve or speed monitoring system activates the braking equipment and the braking equipment brakes the cage to a standstill by means of an associated brake unit or associated brake units and holds it at standstill. During the braking process the brake adjusting forces and braking forces are measured and a coefficient of friction (μb), which is ascertained from these measurements, of the brake unit is compared with the previously determined effective coefficient of friction (μe) of the brake unit. Placing of the braking equipment in operation is designated fulfilled when the ascertained coefficient of friction (μb) substantially corresponds with the effective coefficient of friction (μe), if need be with consideration of the correction factor (KB1, KB2). The advantage of this refinement is to be seen in that the overall function of the safety system of the lift installation can be carried out by simple means by only one person.

A further advantageous refinement of the method of placing in operation proposes that a correct equilibration of a lift system is undertaken or verified with use of the braking force measuring device. This is economic, since no separate measuring instruments are required.

Advantageously the equilibration of the lift system is carried out in that a required equilibration factor is input into an evaluating unit. The actual imbalance (MB) can be ascertained, as described in the foregoing, with use of the braking force measuring device. An effective equilibration factor (Bw) is determined in that the actual imbalance (MB) is correlated with the permissible useful load (MF) of the lift cage. A possible required additional weight can be calculated in simple manner as the difference of the required equilibration factor (Bg) minus the effective equilibration factor (Bw) and multiplication by the permissible useful load, and the counterweight can be charged with this additional weight or, in the case of a negative result, correspondingly relieved. The advantage of this embodiment is that an equilibration can be checked and/or corrected in simple, secure and efficient manner.

Advantageously the number of brake units used is two or a multiple of two. This is of advantage, since usually two brake tracks are present and thus the brake units can be distributed symmetrically on the brake tracks. It is also possible to use, instead of large brake units, several small brake units. This is economic, since modular items of braking equipment can be combined to form a system.

Advantageously characteristic magnitudes, which are detected within the scope of placing in operation, of the brake unit are checked for correspondence with preset values. For the purpose of checking a function in normal operation these placing-in-operation values, or characteristic magnitudes ascertained in the placing in operation, are stored and a continuous status check evaluates the characteristic values in each braking use of the braking equipment in normal operation. The status check continuously compares ascertained characteristic values with the placing-in-operation values and, in the case of unexpected deviations, generates a recalibration, a service notification or a fault report. This allows guaranteeing of the function of the braking equipment over a long period of time and permits focussed maintenance.

Advantageously the ascertained effective coefficient of friction (μe) is used as characteristic magnitude. Alternatively or additionally an ascertained normal force characteristic curve, which is stored as a function of an adjustment measuring device or an adjustment path, is used as characteristic magnitude. These characteristic magnitudes are basic magnitudes which enable a safe statement with respect to braking capability and thus with respect to the safety state of the braking equipment and thus the lift installation.

In an advantageous refinement a correct functioning of the braking force measuring equipment is checked by means of comparison of a measured braking force (FB) with a drive force (FA) required for moving the lift cage, wherein for this purpose a static braking force (FBst) is measured when the lift cage is stationary and a dynamic braking force (FBdyn) is measured at constant travel speed and brake adjusting force (FBw) with smaller action and the difference of these two measurements (FBdyn−Fbstat) is compared with the required driving force (FA), for example a motor torque (TA). This method allows a further or alternative assessment of the safety state of the lift installation or of the measuring system.

Advantageously, for carrying out the method of placing in operation use is made of equipment which is connectible with the braking equipment and which controls the course of the placing in operation. This is particularly advantageous, since by means of this equipment it is possible, for example, to give instructions to the person carrying out the work. Calculations can be performed automatically and the results of the placing in operation stored or can be issued in a report. This is safe and efficient.

Further details of the invention and supplementary advantages thereof are explained in more detail in the following part of the description.

The invention is explained in more detail in the following by way of examples of embodiment in conjunction with the figures. The figures are shown schematically and not to scale. Equivalent parts are denoted in the same way in the figures.

There:

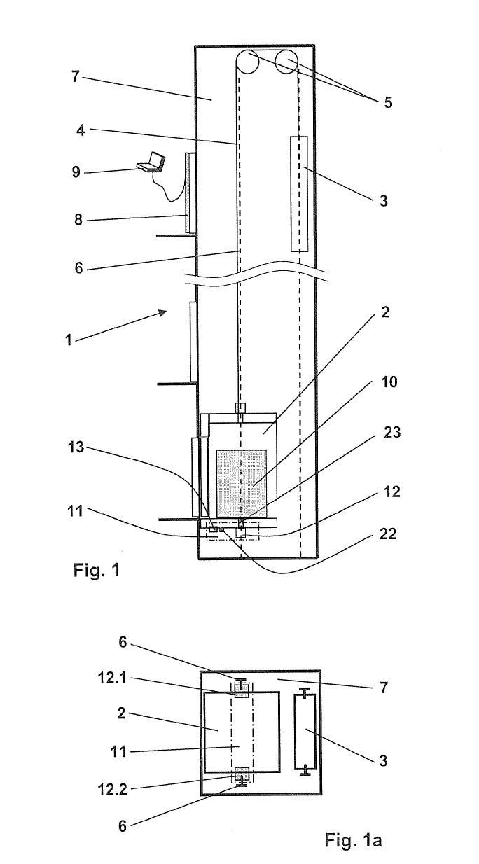

FIG. 1 shows a view of the lift installation with lift cage, counterweight and braking equipment attached to the lift cage,

FIG. 1a shows a plan view of the lift cage and counterweight of the lift installation according to FIG. 1,

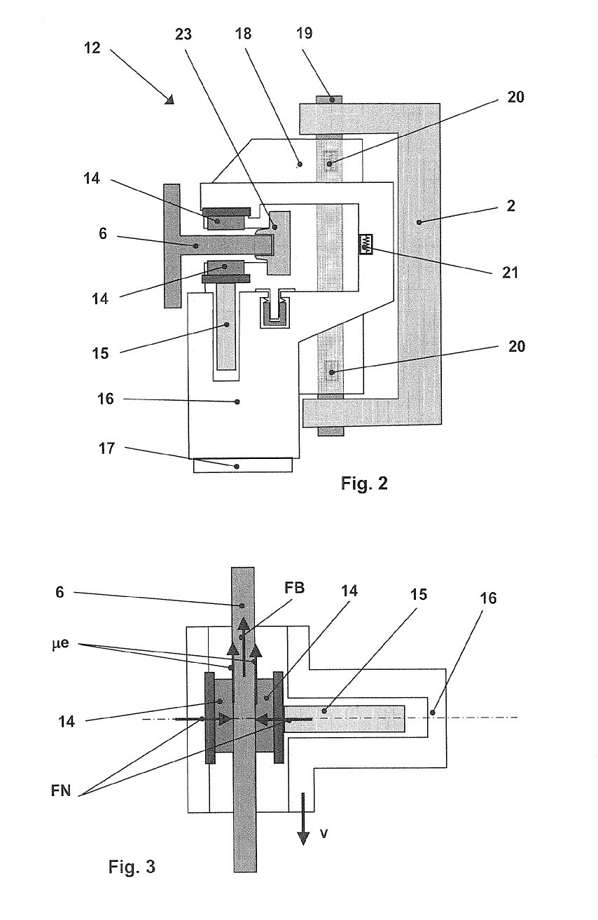

FIG. 2 shows a detail view of a brake unit considered from above,

FIG. 3 shows a detail view of a brake unit,

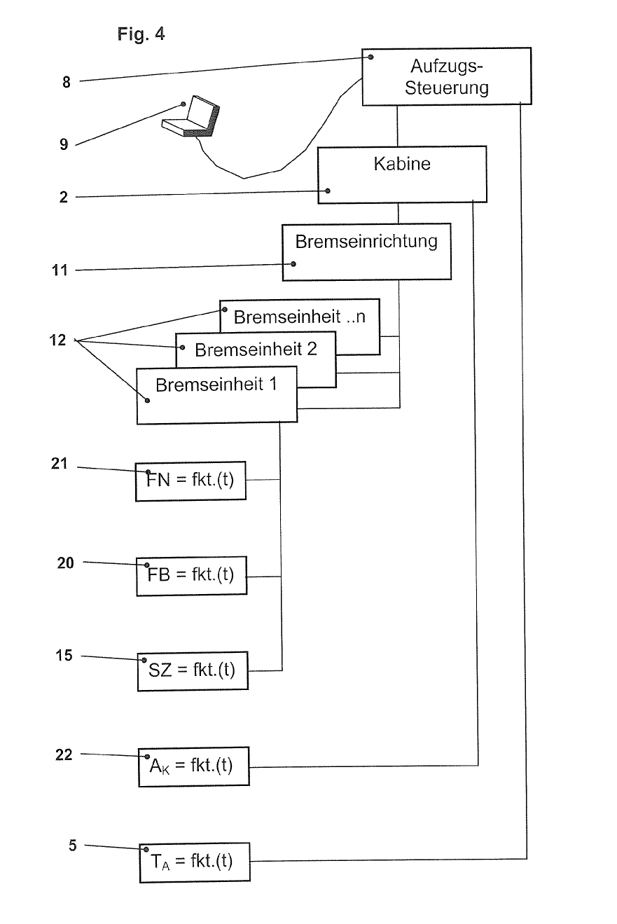

FIG. 4 shows a schematic illustration of a measuring arrangement,

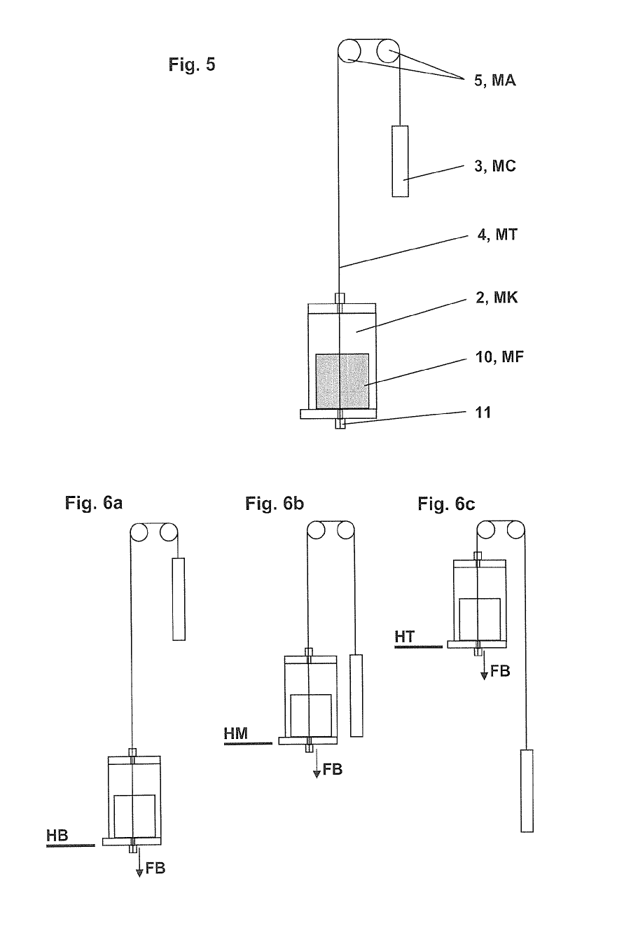

FIG. 5 shows a view of a mass distribution of a lift installation,

FIG. 6a shows mass distribution of a lift installation with cage at the lowermost stop,

FIG. 6b shows mass distribution of a lift installation with cage in a centre position and,

FIG. 6c shows mass distribution of a lift installation with cage at the uppermost stop.

FIG. 1 shows an example of a lift installation 1. The lift installation 1 comprises a lift cage 2 which is connected with a counterweight 3 by way of support means 4. The lift cage 2 is driven by a drive 5 by way of support means 4. The lift cage 2 is guided by guide rails 6 substantially in vertical direction in a lift shaft 7 by means of guide shoes 23. Lift cage 2 and counterweight 3 move in opposite sense in the lift shaft 7. The lift cage 2 serves for the transport of load 10 to be conveyed. The lift installation 1 is controlled by a lift control 8. In the illustrated example the lift cage 1 is provided with braking equipment 11, which can hold the lift cage 2 at standstill and which can, if required, brake the lift cage 2 from a travel state to standstill. Holding at standstill is required, for example, when the lift cage stands at a floor for the purpose of reception or discharging of load 10 to be conveyed. Braking can be required if a fault is established in the lift installation and accordingly the lift cage has to be rapidly decelerated.

The braking equipment 11 comprises at least one brake unit 12 which can be brought into engagement with a brake track 6. In the illustrated example according to FIG. 1 the guide rail 6 and the brake track 6 are one and the same element. The braking equipment 11 further comprises a brake control unit 13 controlling the brake unit 12. The brake control unit 11 presets, to the brake unit 12, braking values which set the brake unit 12. In addition, in the illustrated example an acceleration sensor 22, which detects an instantaneous acceleration state of the cage 2 and passes this on at least to the brake control unit 13 and/or the lift control 8, is mounted at the cage 2. In FIG. 1 in addition equipment 9 which controls a method of placing the lift installation 1 in operation is connected with the drive control 9. In the example this equipment 9 is a mobile computer, such as a laptop, PDA or similar. This equipment 9 contains the required evaluating and control routines in order to carry out, in simple manner, placing of the lift installation 1 or the braking equipment 11 in operation.

FIG. 1a shows the lift installation, which is illustrated in FIG. 1, in a schematic plan view of the lift cage 2. The lift cage 2 is guided by two guide rails or brake tracks 6. The counterweight 3 is disposed in the same shaft 7 and is guided along own guide rails (not shown). The braking equipment 11 is mounted on the lift cage 2, wherein in the example two brake units 12.1, 12.2, which can each act on a respective brake track 6, are used.

FIG. 2 and FIG. 3 show a brake unit 12 by way of example. The brake unit 12 comprises a brake housing 16 with a fixed brake plate 14 and an adjusting device 15 comprising a second brake plate 14. The brake unit 12 embraces the brake track 6 and the brake plates 14 can be adjusted by means of the adjusting device 15, whereby a braking or holding force can be produced. The adjustment is controlled and regulated by means of a control device 17. The guide shoe 23 serves for guiding brake unit 12 and/or lift cage 2. A normal force FN generated by the brake unit 12 is measured by a normal force measuring device 21. The normal force FN generates the braking force FB, which is defined by a coefficient of friction μ. For the sake of simplicity a single braking force FB per brake unit is measured and a coefficient of friction μ is ascertained therefrom, which coefficient of friction corresponds with the value FN divided by FB, i.e. it is a coefficient of friction referred to a brake unit. An attached housing 18 conducts, in the illustrated example, the braking force FB from the brake plates 14 by way of a support pin 19 to the lift cage 2. The braking force can be measured by a braking force measuring device 20. The measured values of normal force FN, braking force FB or an adjustment travel, which can be measured, by way of example, in the adjusting device 15, are detected by the control units 17 and passed on to the placing-in operation equipment 19 directly or if need be by way of the brake control unit 13 and/or lift control 8. Obviously these measurement values are also used by the control device 17, brake control unit 13 and/or lift control 8 for their own tasks.

During braking the brake unit 12 slides along the brake track 6 at a speed v, the speed v being equal to zero in the case of stopping. This embodiment allows an efficient regulation of the braking equipment 11 in the operational case, since the brake control unit 13 can preset a desired normal force FM at each brake unit 12 and the brake unit 12 can automatically set this value. In the case of placing in operation these values can be used in simple manner for calculation of an effective brake safety SB.

FIG. 4 schematically illustrates a possible measuring arrangement for realisation of the method of placing in operation. The drive 5 is provided with a device for detecting the drive moment TA. The drive makes this measurement signal available to the drive control 8. The lift cage 2 is equipped with the acceleration sensor 22. The signal of the acceleration sensor 22 is similarly made available to the lift control 8 by way of the cage. The cage 2 contains the braking equipment 11, which consists of several brake units 12. Each of the brake units 12 has normal force measurement 21, braking force measurement 20 and, in the illustrated example, additionally measurement of the effective adjustment travel of the adjusting device 15. The measurement values are ultimately similarly made available to the lift control 8 by way of the brake unit or the measurement signals are made available by way of the lift control 8 to the equipment 9 for controlling the method of placing in operation. In the illustrated example the equipment 9 is connected with the lift control 8. This enables operation of the equipment from a floor. The equipment could obviously be connected with other data points such as, for example, the brake control unit 13 or the braking equipment 11.

The equipment 9 for controlling the method of placing in operation controls the inspection process and gives required instructions to operating personnel.

FIG. 5 gives an overview of the principal masses of a lift installation. The cage 2 with the empty mass MK is connected with the counterweight 3 by a support means 4, which has the mass MT. The counterweight 3 has the mass MC. The drive 5, which drives the cage 2 and the counterweight 3 by way of the support means 4, has a mass equivalent MA, which corresponds with the rotational mass of the drive components 5. The cage 2 is laden with a maximum permissible load 10 to be conveyed, which corresponds with the mass MF. The cage 2 is provided with braking equipment 11.

FIGS. 6a to 6c give an illustration of possible measuring points for placing the braking equipment 11 or the lift installation 1 in operation. The cage is unladen, i.e. the instantaneous mass MF is zero. FIGS. 6a to 6c are to be considered in conjunction with FIG. 5.

In FIG. 6a the measuring point is illustrated at the lowermost stop HB. In this connection, the mass proportion MT of the support means 4 is disposed substantially on the side of the cage 2. The measurement FB corresponds with the excess weight of counterweight 2 with respect to empty cage 2 and support means 4.

In FIG. 6b a measuring point at the centre stop HM is illustrated. Cage 2 and counterweight 3 are at the same level and the mass proportion MT of the support means 4 is divided substantially uniformly between the side of the cage 2 and that of the counterweight 3. The measurement FB corresponds with the sole excess weight of counterweight 2 with respect to empty cage 2.

In FIG. 6c the measuring point at the uppermost stop HT is illustrated. In this connection the mass proportion MT of the support means 4 is disposed substantially on the side of the counterweight 3. The measurement FB corresponds with the excess weight of counterweight 2 and support means 4 with respect to the empty cage 2. The measuring point according to FIG. 6b can obviously also be ascertained as a mean value between the measurement value according to FIG. 6a and that of FIG. 6c.

With knowledge of the present invention the lift expert can change the set forms and arrangements as desired. For example, the illustrated arrangement of a drive in a shaft head can be replaced by a drive on the cage or at the counterweight or the braking equipment can be arranged at the upper end of the cage or below and above the cage or also laterally of the cage.

1. Method of checking lift braking equipment, which lift braking equipment (11) brakes and holds a lift cage (2) and which lift braking equipment (11) consists of a number of brake units (12) which as required are brought into engagement with brake tracks (6), wherein the brake unit (12) for this purpose presses at least one brake plate (14) against the brake track (6) and produces a braking force (FB), characterised in that an effective coefficient of friction (μe) of the brake unit generated during pressing of the brake plate (14) against the brake track (6) is ascertained.

2. Method according to claim 1, characterised in that the effective coefficient of friction (μe) of the brake unit is ascertained by means of a braking force measuring device (20) for measuring a braking force (FB) and by means of a normal force measuring device (21) for measuring a brake adjusting force (FNw) which acts.

3. Method according to claim 2, characterised in that for ascertaining the effective coefficient of friction (μe) of the brake unit (12) the brake unit (12) is brought into engagement with the brake track (6) and is adjusted by a brake adjusting force (FNw) with smaller action, and the lift cage (2) is moved at low speed, wherein the process of moving is continued or repeated until a substantially constant effective coefficient of friction (μe=FB/FNw) of the brake unit sets in.

4. Method according to claim 3, characterised in that the ascertaining of the effective coefficient of friction (μe) of the brake unit is carried out on the unloaded lift cage (2).

5. Method according to one of claims 2 to 4, characterised in that a sufficient brake safety factor (SB) is proven by way of the effective coefficient of friction (μe) and a maximum brake adjusting force (FNm) ascertained by means of the normal force measuring device.

6. Method for placing in operation a lift installation (1) with a lift cage (2) for transporting a load (10) to be conveyed and with a counterweight (3) connected with the lift cage (2) by way of support means (4) and a drive (5) for driving lift cage (2), counterweight (3) and support means (4), wherein counterweight (3) and cage (2) move in opposite sense in a vertical shaft (7), and with lift braking equipment (11) mounted at the lift cage (2), characterised in that a check of the lift braking equipment (11) is carried out with use of the method according to one of claims 1 to 5.

7. Method according to claim 6, characterised in that a residual mass (MV), which is to be braked in the ‘worst case’ by the lift braking equipment (11), of the lift installation is calculated with input of a permissible weight (MF) of the load (10) to be conveyed and input of a weight (MK) of the empty lift cage (2) (MV=MK+MF) or is calculated with input of the permissible weight (MF) of the load (10) to be conveyed, an operative mass proportion of the drive (MA) and measurement of a lift acceleration (ak), wherein mass determinations at the lift installation, such as an actual imbalance (MB) of the lift installation or an actual weight (MT) of the support means (4), are undertaken with use of the braking force measuring device (20).

8. Method according to claim 6, characterised in that a maximum required brake adjusting force (FMe) is determined with consideration of the total mass (MV) which is to be braked in the ‘worst case’, the effective coefficient of friction (μe) of the brake unit, the number (N) of brake units used, a required minimum retardation (ake) and a correction factor (KB1), wherein the correction factor (KB) takes into account characteristic empirical values such as speed of braking, contamination or anticipated overload:
FNe=KB1*MG*(ak+G)/(N*(μe).

9. Method according to claim 8, characterised in that the brake unit (12) is adjusted with a maximum force and the maximum brake adjusting force (FNm) achievable in that manner is measured by means of the normal force measuring device (21) and this maximum brake adjusting force (FNm) is compared with the maximum required brake adjusting force (FNe) and evidence of sufficient braking function is designated fulfilled when the maximum brake adjusting force (FNm) is greater than the maximum required brake adjusting force (FNe) by the safety factor (SB).

10. Method according to claim 9, characterised in that the brake unit (12) is adjusted with a maximum force and the maximum brake adjusting force (FNm) achievable in that manner is measured by means of the normal force measuring device and a maximum possible braking force (FBm=KB2*2*FNm*N*μe) is determined with consideration of the effective coefficient of friction (te) of the brake unit, the number (N) of brake units used and a correction factor (KB2), wherein the correction factor (KB2) takes account of characteristic empirical values such as speed of braking or contamination.

11. Method according to claim 10, characterised in that a maximum required braking force (FBe) is determined with consideration of the weight (MV) to be braked in the ‘worst case’, a required minimum retardation (ake) and a correction factor (KB2′), wherein the correction factor (KB2′) takes into account characteristic empirical values such as anticipated overload (FBe=KB2′*MV*(ake+G)), and the maximum possible braking force (FBm) is compared with the maximum required braking force (FBe) and evidence of sufficient braking function is designated fulfilled when the maximum possible braking force (FBm) is greater than the maximum required braking force (FBe) by the safety factor (SB).

12. Method according to any one of claims 6 to 11, characterised in that braking function is verified in that the empty cage (2) is accelerated in controlled or uncontrolled manner, preferably in upward direction, until a travel curve or speed monitoring system of the braking equipment (1 1) activates and the braking equipment (11) brakes the cage (2) to a standstill and keeps it at standstill by means of an associated brake unit (12) or associated brake units (12), wherein during the braking process the brake adjusting forces (FN) and braking forces (FB) are measured and an instantaneous coefficient of friction (μb), which is ascertained from these measurements, of the brake unit is compared with the previously ascertained effective coefficient of friction (μe) of the brake unit and placing of the braking equipment (11) in operation is designated fulfilled when the ascertained instantaneous coefficient of friction (μb) substantially corresponds with the effective coefficient of friction ([le), if need be with consideration of the correction factor (KB1, KB2).

13. Method according to one of claims 6 to 12, characterised in that a correct equilibration of a lift system (1) is undertaken or verified with use of the braking force measuring device (20).

14. Method according to claim 13, characterised in that an equilibration of the lift system (1) is undertaken in that a requisite equilibration factor is input, an effective equilibration factor is ascertained at an uppermost stop (HT) and at a lowermost stop (HB) in that the sum of the braking forces of the number (N) of brake units (12) is measured at the two positions with empty lift cage (2) stationary and a mean value of these two measurements is placed in relationship to the permissible useful loading (MF) of the lift cage, and a required additional weight is ascertained as a difference from the requisite equilibration factor (Bg) minus the effective equilibration factor (Bw) and multiplication by the permissible useful loading (MF), and a counterweight (3) is charged with this additional weight or, in the case of a negative result, correspondingly relieved.

15. Method according to any one of claims 6 to 14, characterised in that the number of brake units (12) is two or a multiple of two.

16. Method according to any one of claims 6 to 15, characterised in that characteristic magnitudes of the brake unit (12) are detected within the scope of the placing in operation, checked for correspondence with preset values and stored for the purpose of checking a function in normal operation, wherein a continuous status check (17) in the case of every braking use of the braking equipment (11) evaluates the characteristic values, compares them with placing-in-operation values and in the case of unexpected deviations a re-calibration, service notification or fault report is generated.

17. Method according to claim 16, characterised in that the ascertained effective coefficient of friction (μe) is used as characteristic magnitude and/or an ascertained normal force characteristic curve, which is stored as a function of an adjustment measuring device, is used as characteristic magnitude.

18. Method according to claim 6, characterised in that a correct functioning of the braking force measuring device (20) is checked by means of comparison of a measured braking force (FB) with a drive force (FA) required for moving the lift cage (2), wherein for this purpose a static braking force (FBst) is measured when the lift cage (2) is stationary and a dynamic braking force (FBdyn) is measured at constant travel speed and with brake adjusting force (FBw) with smaller action and the difference of these two measurements (FBdyn−Fbstat) is compared with the required drive force (FA), for example a motor torque.

19. Equipment for carrying out placing in operation in accordance with any one of claims 6 to 18, characterised in that the equipment (9) is connectible with the braking equipment (11) and controls the course of the placing in operation.
